(19) United States
(12) Patent Application Publication
(10) Pub. No.: US 2013/0218642 A1
(43) Pub. Date: Aug. 22, 2013

(54) System and Method For Business Decision Making

(71) Applicant: Nathan Tirosh, Tel Hanan (IL)

(72) Inventor: Nathan Tirosh, Tel Hanan (IL)

(21) Appl. No.: 13/398,937

(22) Filed: Feb. 17, 2012

(51) Int. Cl. G06Q 10/00

(52) U.S. Cl. 705/7.36

(57) ABSTRACT

The invention provides a novel extension of the SWOT (strength/weakness opportunity/threat) paradigm, whereby the various factors are quantified and given weights. The weighted values are summed to provide a two-dimensional representation of the current state, which may be tracked over time for instance as a vector in Cartesian coordinates.

### BACKGROUND

1. Technical Field

Embodiments of the present invention relate generally to systems and methods for making business decisions in an informed and calculated manner.

2. Description of Related Art

The SWOT (Strengths, Weaknesses, Opportunities, Threats) analysis technique has been known for some time to allow for making decisions about what a given entity such as a business, other organization, or even individual should endeavor. Certain drawbacks however are also known such as the failure of such models generally to take into account the different relative importance of various factors.

Hence, an improved method for SWOT analysis is still a long felt need.

### BRIEF SUMMARY

An aspect of the present invention provides a method for informed decision making comprising steps of:
a. identifying influencing factors IF concerning strengths, weaknesses, opportunities, and threats SWOT;
b. assigning a relative weight RW to each said influencing factor;
c. assigning a weighted intensity WI based upon the value of each said influencing factor;
d. deriving a weighted power intensity WPI based upon said relative weights and said weighted intensities for each of said influencing factors IF;
e. calculating a leading strategy LS based upon said weighted power intensity WPI for each of said strengths, weaknesses, opportunities and threats;
wherein a leading strategy LS is determined based upon quantification of the effects of said influencing factors IF.
   The method of claim 1 wherein said weighted power intensity WPI is calculated for each of said Strengths, Weaknesses, Opportunities and Threats according to the formula

$${WPI}_{S , W , O , T} = {\sum }_{IF ( S , W , O , T )} RW \cdot WI$$

It is further within provision of the invention wherein said influencing factors may vary with time.

It is further within provision of the invention wherein said leading strategy is calculated according to a function of the difference between said weighted power intensity for strengths less that of weaknesses, and that of opportunities less that of threats;

LS=f(WPI_{S}−WPI_{W},WPI_{O}−WPI_{T})

It is further within provision of the invention implementing a vectorial representation of said leading strategy LS, plotting said weighted power intensity elements (WPI_{S}−WPI_{W},WPI_{O}−WPI_{T}) as a vector in Cartesian coordinates.

It is further within provision of the invention wherein said vectorial representation is tracked over time.

It is further within provision of the invention wherein said influencing factors, relative weights of influencing factors are selected from the group consisting of: economics; market potential; human resources; R&D; regulation; infrastructure; politics; ecologic; environmental.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates a SWOT diagram of prior art;

FIG. 2 illustrates a SWOT analysis chart of prior art;

FIG. 3 illustrates a canonical SWOT diamond chart;

FIG. 4 illustrates an actual SWOT diamond chart;

FIG. 5 illustrates a growth/leverage/response/survival vector analysis chart;

FIG. 6 illustrates a SWOT clock move diagram;

FIG. 7 illustrates a SWOT CLOCK methodology diagram;

FIG. 8 illustrates a SWOT-time diagram;

FIG. 9 illustrates a training/research/consulting diagram.

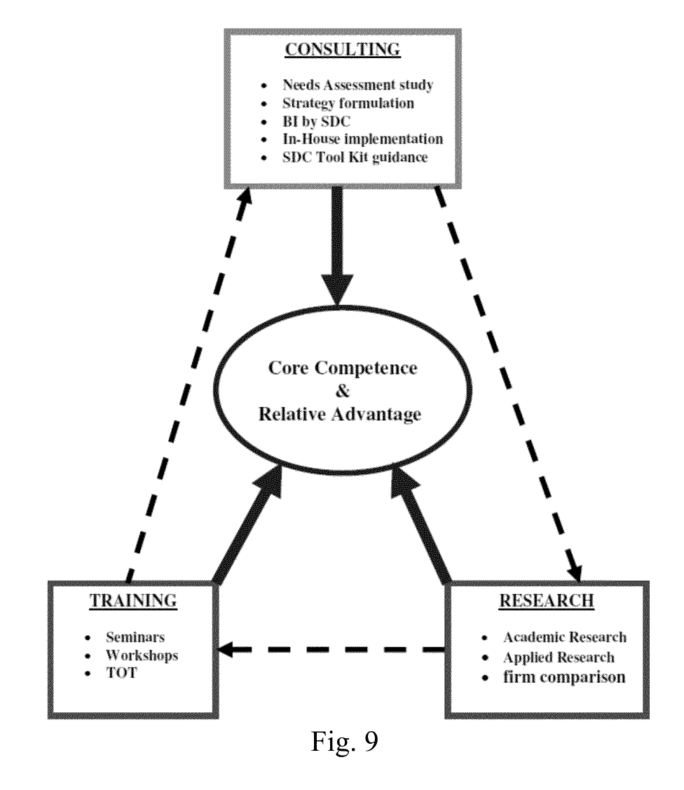

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for business decision making.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1, 5, or 10).

### Introduction—What is SWOT?

SWOT analysis is a business philosophy based on evaluation of Strengths, Weaknesses, Opportunities, and Threats involved in a project or in a business venture. This generally involves specifying the goal(s) of a business venture or project, and identifying the internal and external factors that are favorable and unfavorable to achieve that objective. The technique is credited to Albert Humphrey, who led a convention at Stanford University in the 1960s and 1970s that presented the method, using data from Fortune 500 companies.

By means of SWOT analysis objectives can be set based on achievable goals for the organization. The four components of SWOT analysis are:
Strengths: characteristics of the business, project, or team that give an advantage over others;
Weaknesses (or Limitations): are characteristics that place the team at a disadvantage relative to others
Opportunities: external chances to improve performance (e.g. make greater profits) in the environment
Threats: external elements in the environment that could cause trouble for the business or project

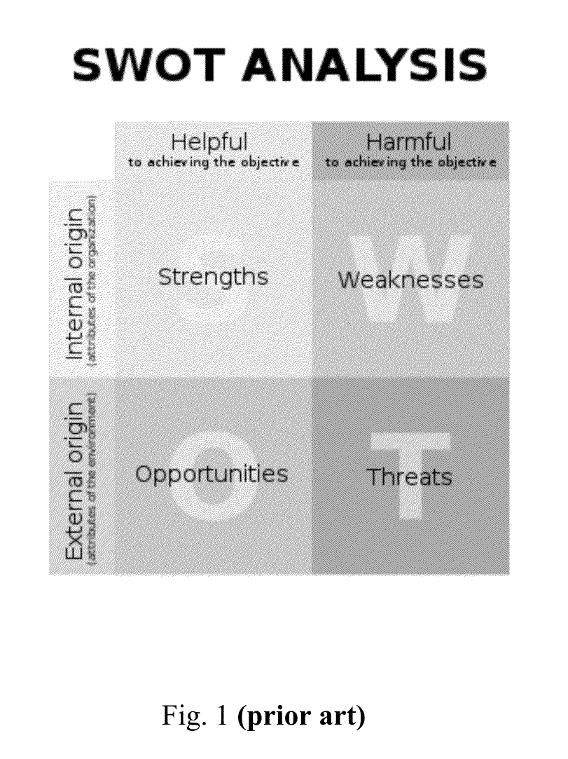

These elements are illustrated in FIG. 1 which identifies the origin and type of each component element. Identification of these elements is considered by SWOT proponents to be essential, as subsequent steps in the process of planning for achievement of the selected objective may be derived therefrom.

Typically SWOT analysis occurs in several steps. First, planners determine whether the objective is attainable, given the SWOTs. If the objective is NOT attainable a different objective must be selected and the process repeated. SWOT analysis is often helpful in identifying areas for development.

The aim of any SWOT analysis is to identify the key internal and external factors that are important to achieving the objective. These come from within the company's unique value chain. SWOT analysis groups key pieces of information into two main categories:
Internal factors—The strengths and weaknesses internal to the organization.
External factors—The opportunities and threats presented by the external environment to the organization.

The internal factors may be viewed as strengths or weaknesses depending upon their influence on the organization's objectives. What may represent strengths with respect to one objective may be weaknesses for another objective. The factors may include price, place, promotion, product as well as personnel, finance, manufacturing capabilities, and so on. The external factors may include macroeconomic matters, technological change, legislation, ecological, political and socio-cultural changes, as well as changes in the marketplace or competitive position. The results are often presented in the form of a matrix.

One common way of utilizing SWOT is matching and converting. Matching is used to find competitive advantages by matching the strengths to opportunities. Converting refers to conversion of weaknesses or threats into strengths or opportunities; one example of conversion strategy is to find new markets. If the threats or weaknesses cannot be converted a company can try, as an alternative, to minimize or avoid them.

It is prudent not to eliminate any candidate SWOT entry too quickly. The importance of individual SWOT elements will be revealed by the value of the strategies it generates. A SWOT item that produces valuable strategies is important and conversely a SWOT item that generates no strategies is not important.

The usefulness of SWOT analysis is not limited to profit-seeking organizations; it may be used in any decision-making situation when a desired end-state (objective) has been defined. Examples include decision making processes in non-profit organizations, governmental units, and individuals. SWOT analysis may also be used in pre-crisis planning and preventive crisis management, or for creating a recommendation during a viability study/survey.

According to the SWOT approach, the interaction between the organization's capabilities and resources are examined from the view point of strengths and weaknesses (SW) and between the opportunities and threats (OT) identified in the organization's environment. The external analysis of the environmental forces focuses on identifying opportunities and threats created by the business environment in an effort to find an answer to the critical strategic question “What should the organization be doing?”

On the other hand, internal analysis, that is, analyzing the organization's internal forces, focused on positioning resources (tangible) and capabilities (intangible) from the view point of its strengths and weaknesses. The intraorganization analysis is trying to come up with an answer to the euslly important strategic question: “What can the organization do?”

The SWOT approach is common in the business community because of its simplicity, intelligibility and applicability at the initial level of consolidating the organization's strategy. The approach is perceived as applicable mainly at a micro environment level, and for the short and medium term. At the same time, some organizations have introduced this approach in consolidating their long-term business strategy.

A 3D generalization of this method, the SWOT-landscape indicates in addition to the SWOT elements themselves, which have had or likely will have highest influence in the context of value in use (for ex. capital value fluctuations), this influence being presented as a height for example.

SWOT analysis is obviously simply one method of categorization out of the universe of possibilities, and as such has its particular strengths and weaknesses. As an example of a weakness, SWOT may result in compilation of lists rather than strategic thought about what is actually important in achieving objectives. It also presents the resulting lists uncritically and without clear prioritization so that, for example, weak opportunities may appear to balance strong threats.

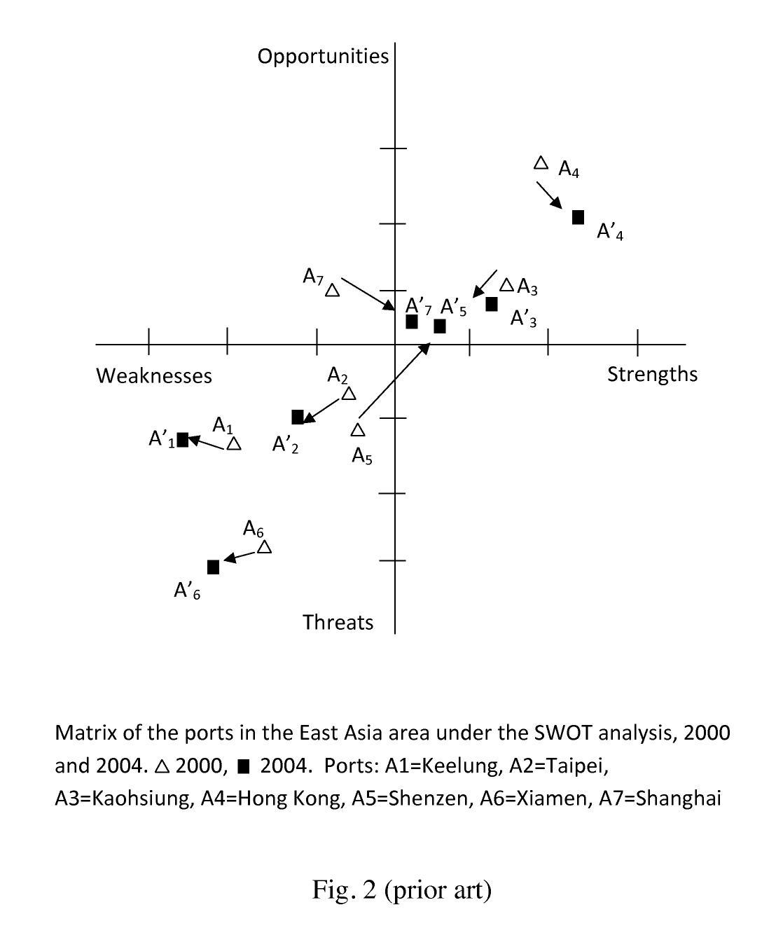

One of the challenges facing researchers and managers in the field of strategy is the need for objective and quantitative presentation of the data base in consolidating the firm's strategy. Chang and Huang (2006) emphasized that most of the studies published presented simplistic approaches while only a few employed quantitative approaches. They conclude that the result of strategic analysis according to the SWOT approach was therefore often superficial, shallow, and inaccurate. The authors applied a complex, quantitative and analytical model in a comparative analysis of strategic positioning of seven ports in China and South-East Asia, including the Hong-Kong Port, Shanghai, and others. The analysis is based on 12 internal factors and on seven external factors of quantitative information drawn from official publications and identifying behavioral situations of the environment, such as geographic location, political stability, macro-economy measures, and so on. The internal factors reflect mainly tangible elements such as storage and handling spaces, efficiency in handling cargoes, customer tariffs, equipment and so on. Taken from Chang and Huang study, FIG. 2 presents the change occurring in the strategic positioning of each of the ports from the year 2000 up to 2004, by an arrow with direction and intensity.

According to the legend of the figure, Hong Kong Port (A₄) moves within the first quadrant and the port maintains its competitive advantage. In comparison, Kaohsiung Port (A₃) has weakened and Shenzhen Port (A₅) was, between the years of 2000-2004, in a process of moving from the third to the first quadrant, building its competitive advantage. On the other hand, in the third quadrant, representing strategic competitive weakness (weaknesses and threats) are positioned the ports of Taichung (A₂) and Xiamen (A₆) that are currently in the process of deteriorating due to strategic erosion.

The main contribution of this study is that it provides an indication of the competitive positioning of each port at any given time. The study was conducted in two stages, the first in the year 2000 and the second in 2004, which allows to identify the trend of the strategic direction. The study should be considered as a breakthrough because it adds the time axis variable, not just as a specific positioning of competitive advantage, but also as an indicator of direction and development process of the strategy.

Against the many advantages found in Chang and Huang (2006) model, it has one salient drawback concerning its applicability at the level of medium and small businesses. The structure of the model and its application are of the highest level of sophistication and complexity, demanding knowledge and the effective capabilities of data collection and processing. These are more suitable to large businesses that are able to carry the high costs of this kind of research. Such requirements pose a large difficulty and raise a higher hurdle when applied to medium and small enterprises. SME's expect a more practical answer that will allow them to achieve similar results to those of Chang and Huang's (2006) model, on the one hand, but that the process of consolidating and shaping strategy will be relatively short and simple in its structure and application, on the other hand.

Along with the advantages of SWOT, several major drawbacks can be discerned:
a. To a large extent, the model is based on ‘qualitative’ and ‘intuitive’ findings and assumptions by decision makers. Such reliance is not supported by ‘quantitative’ data of the environment and the organization's characteristics. This drawback is particularly marked when the overall picture is not easily contrasted in “black and white” colors and the “gray” area is relatively large. Greater sensitivity is then required in analyzing the system to reach appropriate conclusions.
b. Sometimes, it seems that because of time constraints, forcing fast responses, there is a tendency towards over-simplification of the forces that is not always appropriate to the actual situation.
c. The definition of the SWOT factors is often made intuitively.
d. In its essence, the SWOT approach does not analyze situations in which a change process occurs in the strategic positioning on the time axis, except this of Chang and Huang (2006) pioneering study.

Businesses and researchers, who were active in applying the principles of the SWOT approach, have encountered several difficulties, including the following:
a. Determining the number and type of parameters to be employed Subjectivity in evaluating the
b. contribution of the parameters influencing the strategy.
c. The suitable time frame to which the SWOT approach refers, i.e. Short medium or long term.
d. The business level, in which the SWOT approach is employed, i.e. small, medium and large businesses.

The SWOT model was historically used mainly based upon qualitative analysis of the component elements, which, despite various advantages, also inhere several weaknesses. Amongst the weak points are the qualitative assessments required in most cases, and reliance on subjective evaluations, intuition, and the like in comparing various components. The development of business systems up to the early 21st century, especially the information revolution and the globalization dynamic, places enormous challenges before decision makers, who hold the reins of sophisticated management operations involving complex and high-risk (political, economic, social, etc.) actions. The need for innovative management tools, to be used by leaders in the private, public, and social sectors, is only partially met by use of currently available methods and management tools, including the traditional SWOT model, which are tasked with providing solutions to situations unimaginable during their development. This situation is expected to highlight the advantages of an appropriate management model that can help support formulation of business strategy and allow corporate boards of organizations to meet the challenges of 21^{st} century operation.

### Creative Principles

To overcome the weak points of the traditional SWOT model poses a great challenge. What is necessary is the development of approaches and management practices appropriate to the modern information age, including the formulation and design of appropriate strategies for social organizations and public companies in various sectors.

The SWOT CLOCK model approach is an innovative creative management ideas that can help in formulating the strategic direction and organization design. The conceptual innovation of this approach is based on the following principles:
a. At any given moment there is a ‘strategy leader’, a strategy taking into account the close relationship of the firm's internal factors (strengths and weaknesses), and intensity of the external factors of the environment (opportunities and threats). The strategy leader is determined by choosing the most suitable of four possible strategies:—‘growth’, ‘comment’, ‘Survivor,’ and ‘leverage’. The concept of the ‘strategy leader’ (leading strategy) is the first creative conceptual contribution of the model.
b. The power of each of the possible strategies is quantified based on a list of influential factors (internal and external), and a relative weight (weighting factor) is assigned to each impact factor reflecting the priority level and its impact, and the momentary position of influence factors.
c. Unlike traditional approaches that rely on subjective assessments of the importance factors of influence, running a model SWOT CLOCK allows for the implementation of an objective, rational, quantitative system by use of “measurement scales” of quantitative values. This is the second novel creative contribution of the model. In this way the level of subjective involvement and influence in formulating the strategy is ameliorated.
d. The SWOT CLOCK model is a generic model, which can be activated and applied everywhere and at all levels of the management apparatus. One may run such an analysis at the individual human level, at the levels of products and services, workstations, departments, organizations, holding company, the local environment, sectorial, regional and global political levels. The model shows the existence of a dynamic process of strategic change from moment to moment on the timeline. When the time comes to supplement a traditional SWOT model, the third creative conceptual contribution of the model comes into play.
e. The SWOT CLOCK model indicates the existence of a generic process of a regular and consistent transition from one type of strategy leader, to the kind that will follow. According to the model, the order of the transition from leader strategy to others comprises measures such as: ‘growth’—‘comment’—‘Survivor—’ ‘leverage’, and so on. The existence of such transitions to the order of the leader strategy, necessitates a tool for prediction and forecasting of future events. Understanding the order of strategic transitions, drives organizations and political entities to make strategic mistakes, falling into various traps. The main significance of such strategic mistakes is that the organization runs a particular strategy other than that of the strategy leader, it should actually have run. Predictability of the leader strategy is a key characteristic allowing the contribution of ideas appropriate for the fourth contribution of the model.

### Applications and Creative Uses of SWOT Model CLOCK Operation

The SWOT CLOCK model offers innovative applications for running and analysis of strategies. The unique ability to activate and implement the model in different situations that have an important contribution to understanding the strategic behavior of organizations, public companies and the community, is the fifth conceptual contribution of the model.

Amongst the new applications one may point out a few notable examples, such as:
A. The ability to establish firm and update the strategy leader by itself, according to significant changes taking place at the firm and its surroundings from time to time.
B. Ability to run the model in a generic manner offering maximum flexibility, in any location and at (for example) the state level, organizational level and organizational environment. The method provides both measures of effectiveness and efficiency.
C. Ability to position the leadership strategies of firms' various competitors at a given moment, to point towards factors that shift the balance of power, and influence the leading strategies of several rivals.
D. The ability to predict the strategy leader, based on new perspectives on behavior changing processes happening at the firm itself and its business environment.

In an effort to amend these shortcomings, we present a rationalistic typology based on what will be referred henceforward as the ‘SWOT Strategic Clock’ (or the ‘SWOT CLOCK’ model). The methodology proposes a strategy formula which embeds Leading Strategy (LS) as dependent variable with Weighted Power Intensity (WPI) as independent variables. The SWOT CLOCK behavior methodology reflects the affected change of the Leading Strategy (LS) strategy POINTER over the time series scale factor. By means of this approach business and organizations can gain more effective and efficient management tool in their strategy formulation system.

The invention provides a novel extension of the SWOT (strength/weakness opportunity/threat) paradigm, whereby the various factors are quantified and given weights. The weighted values are summed to provide a two-dimensional representation of the current state, which may be tracked over time for instance as a vector in Cartesian coordinates.

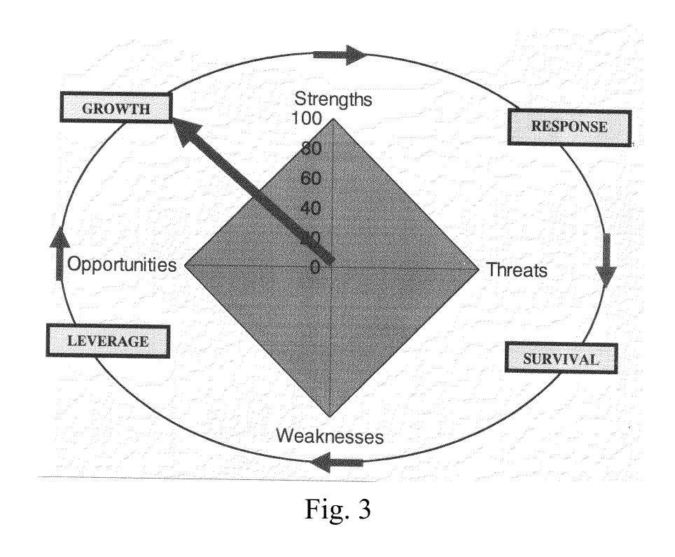

The SWOT CLOCK DIAMOND (SCD, see FIGS. 3,4) may be described using a set of triangle structures, comprising the vertices Training, Consulting & Research. The main objective of providing the proposed services is to assist the organization to enhance its core competence and relative advantage. The model complements the ‘Learning Organization’ methodology and easily is applied at all levels of the organization from top down. The triangle structure is not obligatory and an organization can decide to undertake separately any component given its perspective and preference. It is recommended to first start with training This can be done e.g. through a 3 day In-House seminar or workshop. Later on, it can be continued by a Training Of Trainers (TOT) program, mostly to HR department staff members who will later on, train the other organization employees and will be involved in the In-House SCD implementation process. This process comprises several elements including needs assessment, establishment and strategy formulation of the organization, Monitoring & Evaluation of the SCD implementation phase and followup and guidance of the SCD Tool Kit for success.

The SWOT CLOCK model offers a series of steps and principles in consolidating a business strategy:
a. Principle no. 1—the generic integrated behavior: there is a generic behavior, reflecting the interaction between ‘business environment—organization,’ whose characteristics exist and are derived from the naïve model, as follows:
   i. In each given moment a situation exists in the firm's environment that simultaneously more opportunities can be seen than threats, and vice versa.
   ii. In each given moment a situation exists in the firm that more strengths can be seen than weaknesses, and vice versa.
b. Principle no. 2—defining the independent variables to calculate the intensity of power: the power intensity of the four variables (Opportunities, Threats, Strengths and Weaknesses) could be evaluated by using a matrix (see Table 1 and Table 2, below) that is based on the following components:
   i. Influencing Factor (IF): factors according to which the characteristics of the organization and/or its business environment are analyzed. The list includes factors that in the management and decision makers' view influence the organization's level of power (‘weaknesses’, ‘strengths’) and environmental forces (‘opportunities’, ‘threats’). In general, these factors reflect the perception of the organization's stakeholders. This is also expressed in the studies by Bernroider (2002) and Lee & On Ko (2000). Establishment of the IF can be done by the Delphi approach which reflects individual management perception. After establishment, the list of Influencing Factors is kept constant in the CLOCK strategy formula.
   ii. Relative Weight (RW) of the influencing factor: the importance and influence of any factor that the organization considers to be important in determining and consolidating its strategy. Deciding on the relative weight of the influencing factor is one of the greatest difficulties in applying the SWOT approach. Wheelen and Hungr (2000), David (1986), and others suggest assigning a relative weight to the influencing factor in a subjective and arbitrary manner, on condition that the total sum of the relative weight of all the factors equals to 1 (100%). In this way, it is possible to offset the influence of bias in the final result. The SWOT CLOCK model keeps the Relative Weight as a constant value in the strategy formula.
   iii. A quantitative, Objective Measuring Scale index: a measurable index representing the factor's quantitative value. The index is determined according to the characteristic represented by the factor. For example, the organization's financial situation is determined according to the level of cash flow or an index such as “Altman's Survival Index.”. Productivity index (%) reflects the level of efficiency of operations, and market share (%) reflects the market positioning, and so on.
   iv. Relative Intensity (RI) positioning index: each IF is positioned according to three levels of an Interval Scale: level 3 reflects High position, level 2 Medium position, and level 1 Low position. The objective quantitative measuring index scale is attached to the Interval Scale. For example, Table 1 shows that for Financial Situation IF, a measuring scale in which a surplus of 100K$ exists is defined by the management as a ‘strength’ in level 3. If the financial current situation is of (60) K$ (over draft), it is defined and positioned as a ‘weakness’ in level 3 and so on.
   v. Weighted Intensity (WI): the weighted intensity represents the contribution of each factor to the total power intensity of each of the SWOT variables, calculated as the multiplication of the Relative Intensity (RI) and its Relative Weight (RW) determined according to the current positioning of the appropriate quantitative measuring index. In the example presented in Table 1, the current financial situation is a positive cash flow of about 100K$, and its suitable positioning on the scale is in the ‘strength’ level of 3. Hence, the ‘Weighted Intensity’ will be 105=(3*35).
   vi. Weighted Power Intensity (WPI): reflects the total intensity of all the factors positioned in each of the SWOT variables, and is calculated as the total sum of the Weighted Intensity of those factors. According to the example in Table 1, the Weighted Power Intensity of ‘strengths’ is 155 (105+55), and similarly, that of the ‘weaknesses’ is 77 (45+14+18).
c. Principle no. 3—developing a WPI matrix for the environment and the organization: two matrixes of identical structure exist, one for the business environment and the other for the firm. Using these matrixes it is possible to calculate quantitatively the power intensity of the four SWOT variables. Table 1 presents a hypothetical example for calculating the intensity of internal power (‘strengths’, ‘weaknesses’) and Table 2 presents a hypothetical example for calculating the intensity of environmental powers (‘opportunities’, ‘threats’). Bernroider (2002) concludes that six internal success factors exist for the organization, reflecting the positioning of the ‘strengths’ and ‘weaknesses’, denoting them as ‘physical resources,’ ‘abilities,’ ‘quality,’ ‘contact with customers’ (responsiveness), and ‘innovation’. The organization's management could use these factors and/or others in such a way that will express the business structure & its activities.

TABLE 1
A Matrix for Calculating the Intensity of the Firms ‘Strengths’ and ‘Weaknesses’
A Matrix of the Firm's Power Intensity

| | | | Power intensity of | | | Power intensity of | | |
|---|---|---|---|---|---|---|---|---|
| Influencing | Relative | | ‘strengths’ | | | ‘weaknesses’ | | |
| factor | weight | Measuring Scale | 3 | 2 | 1 | 1 | 2 | 3 |
| Financial | 35 | financial value index | 100 | 60 | 20 | (20) | (40) | (60) |
| situation | | assets (K$) | | | | | | |
| (economic | | Weighted intensity | 105 | | | | | |
| value) | | | | | | | | |
| Control of | 25 | Market share index (%) | 12% | 10% | 8% | 6% | 4% | 2% |
| the market | | Weighted intensity | | 50 | | | | |
| Management | 15 | HR index by (%) of | 1% | 2% | 3% | 4% | 6% | 9% |
| and human | | Motivation & Absentecism | | | | | | |
| resources | | Weighted intensity | | | | | | 45 |
| R&D | 10 | Technological age index | Up to 2 | 2-4 | 4-6 | 6-8 | 8-10 | >10 |
| technology | | (years) | | | | | | |
| | | Weighted intensity | | | | 10 | | |
| Operations | 8 | Production index | 90% | 86% | 82% | 78% | 76% | 72% |
| and | | (efficiency) | | | | | | |
| management | | Weighted intensity | | | | 8 | | |
| processes | | | | | | | | |
| Infrastructure | 7 | Equipment index | Up to 3 | 3-6 | 6-9 | 9-12 | 12-15 | >15 |
| | | (age by no. of years) | | | | | | |
| | | Weighted intensity | | | | | 14 | |
| Total | 100 | Total | 105 | 50 | | 18 | 14 | 45 |

| | | |
|---|---|---|
| Weighted Power Intensity | 155 | 77 |
| (WPI) | | |

Note:
Establishment of the Relative Weight for each factor can be determined either by brainstorming sessions, Delphi approach or experts opinion. The Relative Weight is the only parameter in the SWOT CLOCK model which is determined subjectively, where the established Measuring Scale is objectively defined. In this way the number of the subjective parameters is minimized. Only the Relative Weight index remained as subjective estimate in the SWOT CLOCK model.

According to the example shown in Table 1, the Weighted Power Intensity of the organization's ‘strengths’ is 155, this being the sum of the weighted intensity of the influencing factors: ‘financial situation’ and ‘control of the market.’ The influencing factors ‘Human Resources’ and ‘technology and infrastructure’ reflect a total Weakness Weighted Power Intensity level of 77 (18+14+45).
A second example of a matrix of power intensity for a business environment (‘opportunities’, ‘threats’) is presented in Table 2. Seven influencing factors were defined. In the example, the Power Intensity Index score of Strengths is 39 and the Weakness Power Intensity Index score is 78.

TABLE 2
A Matrix for Calculating the Power Intensity of the Firms ‘Opportunities’ and [symbol]
A Matrix of the Business Environment Power Intensity

| | | | Power intensity of | | | Power intensity of | | |
|---|---|---|---|---|---|---|---|---|
| | Relative | | ‘opportunities’ | | | ‘threats’ | | |
| Influencing factor | weight | Measuring Scale | 3 | 2 | 1 | 1 | 2 | 3 |
| Economic | 30 | Prime interest rate (%) | 3< | 3-3.5 | 3.5-4.0 | 4-5 | 5-7 | >7 |
| situation | | Weighted power intensity | | | | 30 | | |
| Marketing | 25 | Market size index (mil. $) | >20 | 15-20 | 10-15 | 5-10 | 2-5 | 2< |
| potential | | Weighted power intensity | | | | 25 | | |
| Human resources | 15 | Unemployment level | >12 | 11-12 | 10-11 | 9-10 | 8-9 | 7-8 |
| recruitment | | index | | | | | | |
| | | Weighted power intensity | | | 15 | | | |
| R&D technology | 10 | Technological age index | Up to 2 | 2-4 | 4-6 | 6-8 | 8-10 | >10 |
| | | (years) | | | | | | |
| | | Weighted power intensity | | | 10 | | | |
| Regulation | 8 | Aggregation taxation | 15% | 20% | 25% | 30% | 35% | 40% |
| | | index (%) | | | | | | |
| | | Weighted power intensity | | | | 8 | | |
| National | 7 | Investment budget | >40 | 20-40 | 10-20 | 5-10 | 2-5 | 2< |
| infrastructure | | (mil. $) | | | | | | |
| | | Weighted power intensity | | 14 | | | | |
| Political situation | 5 | Annual event frequency | 1 | 1-2 | 2-4 | 4-6 | 6-8 | 8-10 |
| | | Weighted power intensity | | | | | | 15 |
| Total | 100 | Total | | 14 | 25 | 63 | | 15 |

| | | |
|---|---|---|
| Weighted Power Intensity | 39 | 78 |

[symbol]

indicates data missing or illegible when filed

A summary of the Weighted Power Intensity (WPI) of the variables is presented in Table 3.

TABLE 3
Summary of the Weighted Power Intensity
of the variables in the CLOCK model

| | Opportunity | | |
|---|---|---|---|
| Strength Intensity | Intensity | Weakness Intensity | Threat Intensity |
| S | O | W | T |
| 155 | 39 | 77 | 78 |

d. Principle no. 4—consolidating the ‘Leading Strategy’ (LS) direction: four generic strategic directions exist, resulting from the simultaneous integration of the Weighted Power Intensity of the two external factors (‘opportunities,’ ‘threats’) with the two internal factors (‘strengths,’ ‘weaknesses’), which can be defined as follows:
   i. Growth (S+O): a situation in which the WPI of ‘opportunities’ is larger than the WPI of ‘threats’ and that of ‘strengths’ is larger than that of ‘weaknesses.’ The Growth strategy involves in a synergic process to grow and expand. This strategy could be applied by ‘market development,’ ‘product development,’ ‘vertical/horizontal integration,’ ‘diversification,’ ‘market penetration,’ ‘mergers and acquisitions’ (such as Teva Ltd.), and so on.
   ii. Leverage (W+O): a situation in which the WPI of ‘opportunities’ is larger than the WPI of ‘threats’ and that of ‘weaknesses’ is larger than that of ‘strengths.’ The line leading the Leverage strategy. This strategy could be applied in the directions of ‘developing human resources,’ ‘investments in infrastructure and equipment,’ ‘developing business units,’ ‘developing and encouraging innovativeness and creativity,’ and so on.
   iii. Response (S+T): a situation in which the WPI of ‘threats’ is larger than the power intensity of ‘opportunities’ and that of ‘strengths’ is larger than that of ‘weaknesses.’ Therefore, the Response strategy employs ‘strengths’ to push the ‘threats’ away. This strategy could be applied and used by ‘cooperation,’ ‘price war,’ ‘focusing and differentiating,’ ‘performance improvement’, enhanced HR motivation, and so on
   iv. Survival (W+T): a situation in which the WPI of ‘threats’ is larger than the power intensity of ‘opportunities’ and that of ‘weaknesses’ is larger than that of ‘strengths’. The Survival strategy reflects the organization's struggle to maintain its continued existence as a ‘living body.’ In this kind of strategy, action and application modes could include ‘liquidation,’ ‘dismissals,’ ‘closing production lines,’ ‘reducing product basket,’ ‘limiting number of brands,’ ‘vertical integration by the buyer,’ and so on.

Thus the SWOT CLOCK strategy formula can be defined as:

LS=f(WPI)=f(IF,RW,WI)

More particularly, the WPI (weighted power index) can be expressed by the formula

$${WPI}_{S , W , O , T} = {\sum }_{IF ( S , W , O , T )} RW \cdot WI$$

whereby the WPI for each of the SWOT elements is calculated by summing the product of relative weight (RW) and weighed intensity (WI) for each influencing factor (IF) of that SWOT element.

Given this definition, the leading strategy formula can be rewritten in the form

$$\begin{matrix}LS = f ( {WPI}_{S} - {WPI}_{W} , {WPI}_{O} - {WPI}_{T} ) \\ = f ( sgn ( {WPI}_{S} - {WPI}_{W} ) ; sgn ( {WPI}_{O} - {WPI}_{T} ) )\end{matrix}$$

Or in other words the leading strategy takes into account whether strengths are greater than weaknesses, and whether opportunities are greater than threats.

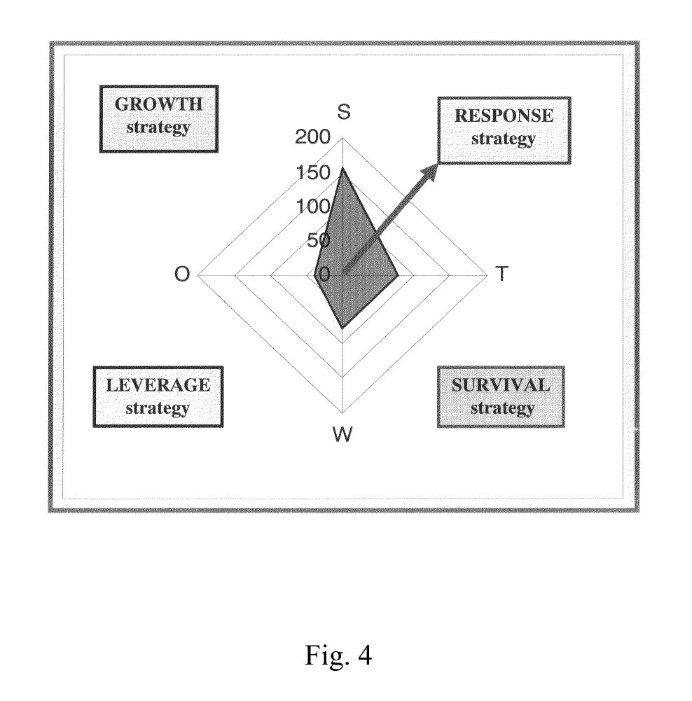

FIG. 4 presents the positioning of the Weighted Power Intensity of each SWOT variable in the ‘SWOT CLOCK Diamond Behavior Model’. Results shown in Table 3 reflect the organization's Response strategy (S+T) quadrant as a Leading Strategy (LS). Placing the values of the Weighted Power Intensity of each variable creates four triangles. Each triangle represents a combination of an external environmental variable with an internal variable of the organization on the corresponding quadrate. Four possible strategies simultaneously at a certain moment in time are created, Growth, Response, Survival and Leverage. Intuitively, the Leading Strategy is determined by the largest triangle in size out of all the possible strategy triangles. In this example, the triangle of the Response strategy quadrant is the largest in size. Therefore it is defined as the Leading Strategy.

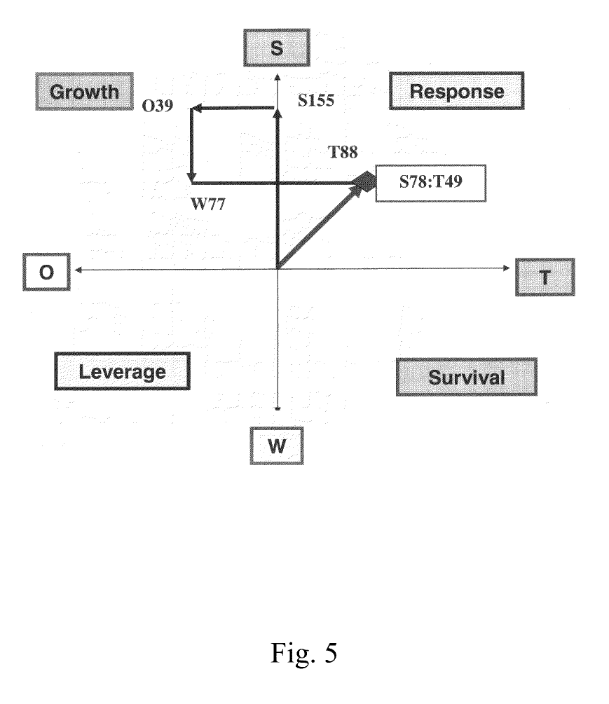

Principle no. 5—‘the Strategic Pointer’: the ‘strategic pointer’ (henceforth, ‘POINTER’) points to the strategic direction that was determined by an analysis of the current position. The ‘POINTER’ is the weighted vector of the four SWOT forces, each having a direction and intensity. FIG. 5 describes the process of strategic positioning for the weighted vector. In the first stage, the WPI of ‘strengths’ is vertically allocated upwards. Then, the allocation of the WPI of ‘opportunity’ continues horizontally to the left. From this point, the WPI of ‘weaknesses’ continues to be allocated downwards, and finally, the WPI of ‘threats’ is allocated to the right. In the example, the weighted vector begins from the origin point (0, 0) to the end point of the last vector S78:T49, and the ‘POINTER’ vector position is indicated accordingly in the ‘RESPONSE’ strategy quadrant. The pointer's positioning is strategically significant. When the pointer's is aligned more vertically in the quadrant of the ‘RESPONSE’ strategy, the organization has a better chance of overcoming ‘threats’. On the other hand, when the pointer's is aligned more horizontally, the situation will be more risky, because relatively, the ‘threats’ direction will be of greater magnitude than that of the ‘strengths’ (see FIG. 5).

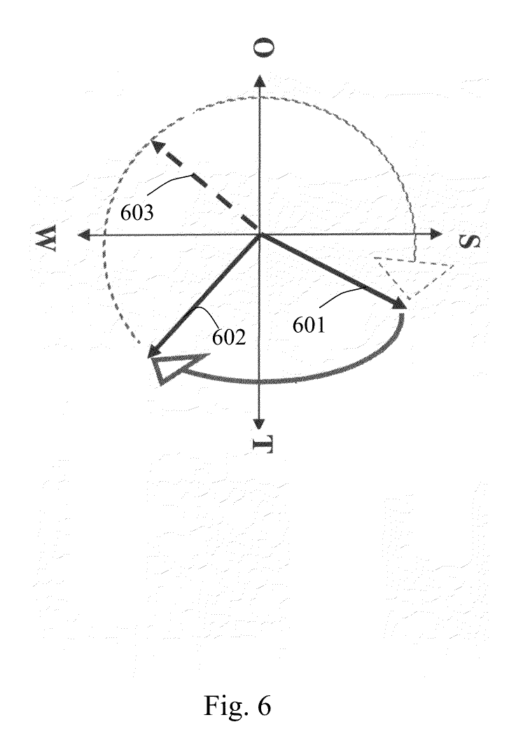

Here the pointer's positioning is momentary. It “turns” according to the corresponding strategic positioning as it changes in time, as described in FIG. 6. For example, at some point in time (say, T₁), the POINTER 601 indicates the ‘RESPONSE’ strategy quadrant, quadrate and the organization applies this strategy. In case the organization does not succeed in operating its strategy, Strengths turn into Weaknesses and the Threats will remain the same, the strategy pointer 602 turns towards the Survival quadrant (at time say, T₂).

This effect is shown in FIG. 6; the pointer position is a temporary one. It could remain in the same strategic quadrant for quite a long time, and change its direction position later on (e.g changing from direction 601 to 602 to 603). This movement is very similar to the pointer's move in an analog clock; hence the model name—“The SWOT CLOCK.” The strategic direction immediately highlights the strategic question of How? That is, How to grow? How to respond? How to lever? and How to survive? For example, how should the organization respond once it has consolidated its strategy of Response? What should be the policy and how should it act regarding the steps it should take actually to use it strengths and push away the threats?

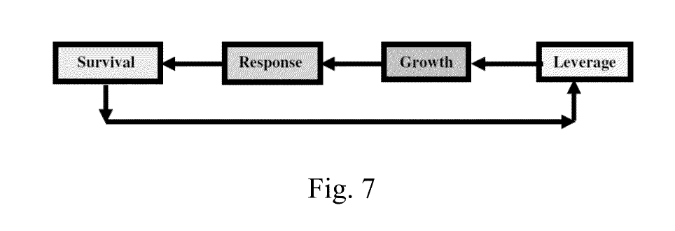

Principle 6—the dynamic process of the pointer and the time series variable: observations on business behaviors indicate an associative relation between the pointer's positioning and its movements on the time scale. According to this principle, the pointer's movement from one strategic quadrate to the next constitutes a cyclical process, as shown by FIG. 7.

Finding support for the hypothesis that the direction of the pointer's movement is clockwise or counter clockwise, is due to some unexpected events (such as disruptive technology, regulation, etc.) is an open field for challenging studies, both academic and empiric.

Features of this process can be expounded upon using the following possible scenario:

At a certain point in time the POINTER indicates the ‘LEVERAGE’ Leading Strategy, applying opportunities to strengthen weaknesses.

At the next point in time, the business combines opportunities and achieves new strengths, affecting the POINTER to move to the GROWTH Leading Strategy quadrant. Afterwards, the business is influenced mainly by competitors, customers and other stakeholders. Severe threats overriding the opportunities move the POINTER to the RESPONSE Leading Strategy quadrate. The business begins to use its strengths to push the threats away.

Two possible strategic results could result. If the business fails to push away the threats with the RESPONSE strategy, it becomes weaker and the POINTER will move to the SURVIVAL Leading Strategy quadrate. If the business succeeds in pushing away the threats, its strengths become weaker as a result. In this case, there are relatively more opportunities than threats and the POINTER will move to the LEVERAGE Leading Strategy quadrate.

Allen Deutchman's (2005) article The Managerial Rabbit of IBM skillfully exemplifies how the principles of the SWOT CLOCK model could explain the behavior of strategic management. The article describes the process of strategic change undergone by IBM since the end of 1999. The CEO Lou Gerstner realized that up until that time IBM used mainly a defensive strategic policy, which corresponds with the Response strategy according to the SWOT CLOCK model. As a result, he identified IBM's weaknesses, on the one hand, and opportunities on the other, consolidating the EBO (Emerging Business Opportunities) theory, which is based on the exploitation of internal abilities, motivation and intra-organizational entrepreneurship against the market forces' threats (competitors, customers). This innovative perception led IBM to a LEVERAGE strategy that was actually executed by the establishment of business entrepreneurship units in areas that were not included in IBM's business core up until that time, such as biotechnology, life science, etc. Since its launch, the EBO program succeeded in creating about 22 ‘living’ projects that produced in 2005 an annual profit of about 15 billion dollars. Since 2005/2006, IBM's strategic managerial policy has been characterized as Growth: a situation in which a significant combination of ‘opportunities’ and ‘strengths’ exists.

Applying the principles of the SWOT CLOCK model also allows small and medium scale businesses, not only large businesses, to use a quantitative/objective tool in shaping their business strategy. The model reduces the influence of the subjective factor on the possible bias of the result, on the one hand, while being more simplistic in the process of strategy on the other, consolidating and expanding the intelligibility of the change process of strategic positioning on the time series axis.

Relation of the ‘SWOT CLOCK’ to the ‘PLC’ and ‘BCG’ Models

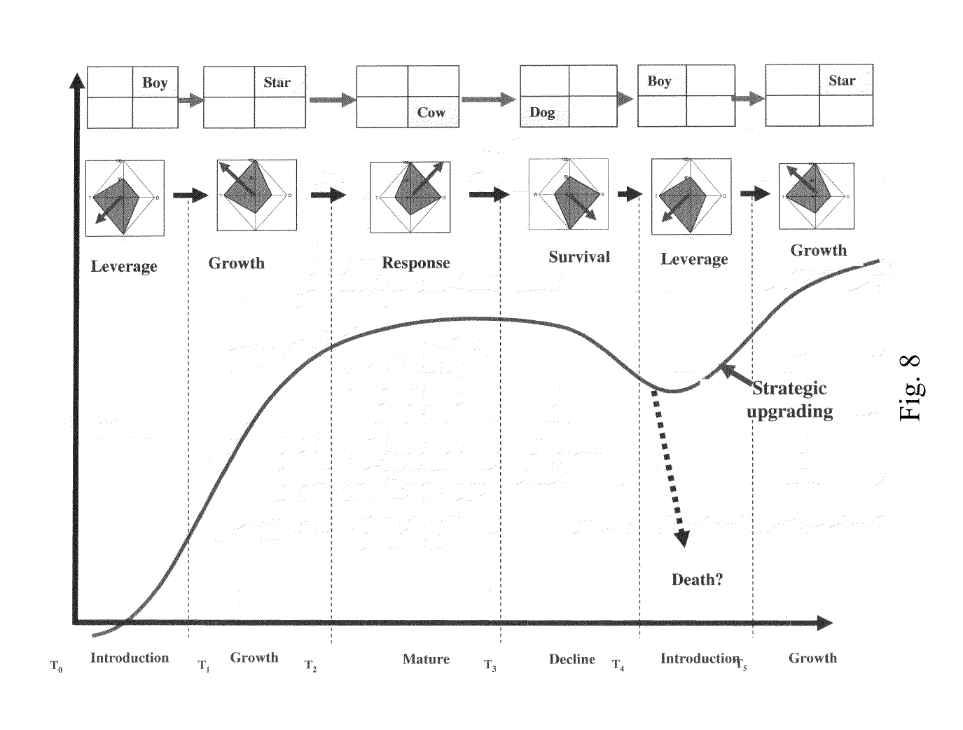

The SWOT CLOCK model explains behaviors of other models in the area of business strategy and provides them with applied validity. One of the many applications is reciprocal positioning with the well-known models of PLC (Product Life Cycle) and BCG (Boston Consultants Group), presented in FIG. 8. The PLC model suggests that similar to the time periods in human life (childhood, adolescence, maturity, old age, and death) a comparable analogy exists with products, organizations and even countries.

According to the PLC model, these periods are defined as ‘Introduction,’ ‘Growth,’ ‘Maturity,’ ‘Decline,’ and ‘Death’, as shown in FIG. 8. At the end of the Decline period there are two possibilities to continue the business activity—death and the end of the activity, or upgrading the activity. According to the SWOT CLOCK model, there are four successive ‘leading strategies’ in the order of ‘LEVERAGE,’ ‘GROWTH,’ ‘RESPONSE,’ and ‘SURVIVAL’ so that, analogically, it is possible to ascribe them to periods in the PLC model.

Characteristics of the BCG model, too, which define four strategic positions—‘boy,’ ‘star,’ ‘milking cow,’ and ‘dog’—correspond to the analogy mentioned with the PLC and the SWOT CLOCK models. As can be seen from FIG. 8, the PLC, BCG and the SWOT CLOCK models overlap each other. This behavior could be described with reference to the time series independent variable as follows:
Time scope T₀-T₁: is characterized by the Introduction period according to the PLC model. This is also the period of the LEVERAGE Leading Strategy according to the SWOT CLOCK model and the Boy positioning according to the BCG model.
Time scope T₁-T₂: is characterized by the Growth period according to the PLC model. This is also the period of the GROWTH Leading Strategy according to the SWOT CLOCK model and the Star positioning according to the BCG model.
Time scope T₂-T₃: is characterized by the Maturity period according to the PLC model. This is also the period of the RESPONSE Leading Strategy according to the SWOT CLOCK model, in which the organization uses its strengths to push away threats of the environment (competitors, etc.). The corresponding positioning according to the BCG model is that of Milking Cow.
Time scope T₃-T₄: is characterized by the Decline period according to the PLC model. This is also the period of the SURVIVAL Leading strategy according to the SWOT CLOCK model. If the Survival strategy does not succeed, business activity will stop and the Death stage will begin. According to the BCG model, the positioning is of the Dog type.
Time scope T₄-T₅: is characterized by the Introduction period according to the PLC model, following the product upgrade. According to the SWOT CLOCK model, this is the LEVERAGE Leading Strategy of the upgraded product, to be followed by the GROWTH Leading Strategy in another cycle after time point T₅. Once again, the positioning according to the BCG will be of kind ‘Boy,’ accordingly.

The SWOT CLOCK model focuses on factors that have significant influence and is employed effectively in situations, particularly when time is too limited to analyze a complex strategic situation. The model acts as a filter that focuses extensive information into applicable dimensions and is able to simplify and apply strategic factors in practice.

Table 4 shows the comparative relation between the strategy components of the three models.

TABLE 4
A Comparative Relation of the SWOT CLOCK, PLC and BCG models

| BCG model | SWOT Clock model | PLC model |
|---|---|---|
| Boy | Leverage | Introduction |
| Star | Growth | Growth |
| Milking Cow | Response | Maturity |
| Dog | Survival | Decline |

Such analogical comparison adds further validation to the veracity of these models and enhances the confidence that a business strategy can be based on the principles of these models actually representing true business behavior.

### 4. Summary

The main goal of a quantitative, behavioral, strategic or any other kind of model is to present a rationalistic and structured system that has a defined goal and could be applied in practice. In the field of business strategy, the main expectation from using the traditional SWOT model is to point to a strategic direction that is based on the behavior of its variables, i.e., opportunities, threats, strengths, and weaknesses. The major drawback of the traditional SWOT model results from the fact that it is based on intuitive and qualitative evaluations. In this sense, it does not fulfill the expectations of its users, making it difficult to define the desired strategic direction for the organization in a sound manner. In addition, it does not consider the time dimension as an independent variable in determining the business strategy.

The SWOT CLOCK model presents a new view point for understanding the organization's strategic behavior at the micro level. The model offers an answer to the basic drawbacks of the SWOT approach and of other models presented in this article, and supplements them to create better understanding and objective, simple, and effective applicability of the SWOT approach. The model also provides appropriate answers to the special requirements and expectations of small and medium scale organizations in consolidating their strategy as well as dealing effectively with large organizations.

The SWOT CLOCK model in comparison with the traditional SWOT model has several important advantages:
a. A more objective and quantitative approach for deciding on the strategic direction.
b. Offering well-defined strategic directions according to the principle of the traditional SWOT model.
c. Applying the concept of time as an independent variable in deciding the business strategic direction.
d. Introducing the cyclical order regime of strategic direction.
e. Giving an applied validity to accepted models in business strategy such as PLC and BCG.
f. Effective, simple and fast application of the traditional SWOT model, mainly in small and medium scale organizations.

The SWOT CLOCK model opens up a wide field of studies to be applied both academically and practically. As will be apparent to one skilled in the art, there are correlations between LS and the WPI variables, and the validity of the SWOT CLOCK strategy sequence on the time series. On the basis of these correlations and validation of the model in real world situations, management executives can confidently adopt the SWOT CLOCK concept to enhance their business strategy formulation process.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A method for informed decision making comprising steps of:
a. identifying influencing factors IF concerning strengths, weaknesses, opportunities, and threats SWOT;
b. assigning a relative weight RW to each said influencing factor;
c. assigning a weighted intensity WI based upon the value of each said influencing factor;
d. deriving a weighted power intensity WPI based upon said relative weights and said weighted intensities for each of said influencing factors IF;
e. calculating a leading strategy LS based upon said weighted power intensity WPI for each of said strengths, weaknesses, opportunities and threats;
wherein a leading strategy LS is determined based upon quantification of the effects of said influencing factors IF.

2. The method of claim 1 wherein said weighted power intensity WPI is calculated for each of said Strengths, Weaknesses, Opportunities and Threats according to the formula
$${WPI}_{S , W , O , T} = {\sum }_{IF ( S , W , O , T )} RW \cdot WI$$

3. The method of claim 1 further wherein said influencing factors may vary with time.

4. The method of claim 1 wherein said leading strategy is calculated according to a function of the difference between said weighted power intensity for strengths less that of weaknesses, and that of opportunities less that of threats;
LS=f(WPI_{S}−WPI_{W},WPI_{O}−WPI_{T})

5. The method of claim 4 further implementing a vectorial representation of said leading strategy LS, plotting said weighted power intensity elements (WPI_{S}−WPI_{W},WPI_{O}−WPI_{T}) as a vector in Cartesian coordinates.

6. The method of claim 5 further wherein said vectorial representation is tracked over time.

7. The method of claim 1 wherein said influencing factors are selected from the group consisting of: economic factors; market potential; human resource considerations; R&D status; regulation situation; infrastructure availability; political context; ecological context; environmental context.

8. A method of informed decision making comprising steps of:
a. obtaining computing means comprising databases of influencing factors concerning strengths, weaknesses, opportunities, and threats SWOT;
b. assigning a relative weight RW to each said influencing factor;
c. assigning a weighted intensity WI based upon the value of each said influencing factor;
d. calculating a weighted power intensity WPI based upon said relative weights and said weighted intensities for each of said influencing factors IF by use of said computing means;
e. calculating a leading strategy LS based upon said weighted power intensity WPI for each of said strengths, weaknesses, opportunities and threats by use of said computing means;
wherein a leading strategy LS is determined based upon quantification of the effects of said influencing factors IF.

9. The method of claim 8 wherein said weighted power intensity WPI is calculated for each of said Strengths, Weaknesses, Opportunities and Threats according to the formula
$${WPI}_{S , W , O , T} = {\sum }_{IF ( S , W , O , T )} RW \cdot WI$$

10. The method of claim 8 further wherein said influencing factors may vary with time.

11. The method of claim 8 wherein said leading strategy is calculated according to a function of the difference between said weighted power intensity for strengths less that of weaknesses, and that of opportunities less that of threats;
LS=f(WPI_{S}−WPI_{W},WPI_{O}−WPI_{T})

12. The method of claim 11 further implementing a vectorial representation of said leading strategy LS, plotting said weighted power intensity elements (WPI_{S}−WPI_{W},WPI_{O}−WPI_{T}) as a vector in Cartesian coordinates.

13. The method of claim 513 further wherein said vectorial representation is tracked over time.

14. The method of claim 8 wherein said influencing factors are selected from the group consisting of: economic factors; market potential; human resource considerations; R&D status; regulation situation; infrastructure availability; political context; ecological context; environmental context.

15. A system for informed decision making comprising:
a. a set of influencing factors IF concerning strengths, weaknesses, opportunities, and threats SWOT;
b. a set of relative weights RW to each said influencing factor;
c. a set of weighted intensities WI expressing the value of each said influencing factor;
d. a weighted power intensity WPI calculated based upon said relative weights and said weighted intensities for each of said influencing factors IF;
e. a leading strategy LS based upon said weighted power intensity WPI for each of said strengths, weaknesses, opportunities and threats;
wherein a leading strategy LS is determined based upon quantification of the effects of said influencing factors IF.

16. The system of claim 16 wherein said weighted power intensity WPI is calculated for each of said Strengths, Weaknesses, Opportunities and Threats according to the formula
$${WPI}_{S , W , O , T} = {\sum }_{IF ( S , W , O , T )} RW \cdot WI$$

17. The system of claim 16 further wherein said influencing factors may vary with time.

18. The system of claim 16 wherein said leading strategy is calculated according to a function of the difference between said weighted power intensity for strengths less that of weaknesses, and that of opportunities less that of threats;
LS=f(WPI_{S}−WPI_{W},WPI_{O}−WPI_{T})

19. The system of claim 16 further wherein a vectorial representation of said leading strategy LS is implemented, plotting said weighted power intensity elements (WPI_{S}−WPI_{W},WPI_{O}−WPI_{T}) as a vector in Cartesian coordinates.

20. The system of claim 19 further wherein said vectorial representation is tracked over time.

21. The system of claim 16 wherein said influencing factors, relative weights of influencing factors are selected from the group consisting of: economics; market potential; human resources; R&D; regulation; infrastructure; politics.
